(19) United States
(12) Patent Application Publication
(10) Pub. No.: US 2010/0165203 A1
(43) Pub. Date: Jul. 1, 2010

(54) VIDEO DISPLAY APPARATUS AND METHOD FOR DISPLAYING VIDEO

(75) Inventors: Joji Yamashita, Tokyo (JP); Atsushi Hirota, Yokohama-shi (JP); Yoshio Kimura, Tokyo (JP); Yumiko Nakajima, Tokyo (JP); Shinichi Ooi, Tokyo (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/554,469

(22) Filed: Sep. 4, 2009

(30) Foreign Application Priority Data
Dec. 25, 2008 (JP) 2008-329992

(51) Int. Cl. H04N 5/50

(52) U.S. Cl. 348/570; 348/E05.097; 348/731; 348/730

(57) ABSTRACT

A video display apparatus includes: a tuner configured to receive a digital broadcast signal; an accepting module configured to accept a power-on command; a display module configured to simultaneously display first information that is included in the digital broadcast signal and second information that is not included in the digital broadcast signal when the accepting module accepts the power-on command.

### CROSS REFERENCE TO RELATED APPLICATION(S)

The present disclosure relates to the subject matters contained in Japanese Patent Application No. 2008-329992 filed on Dec. 25, 2008, which are incorporated herein by reference in its entirety.

### FIELD

The present invention relates to a video display apparatus and a method for displaying video.

### BACKGROUND

Conventionally, when a user activates (powers on) a video display apparatus, the video display apparatus is tuned to a channel (called a last channel) a program on which the user was viewing immediately before the user powered off the video display apparatus last time and displays a program on the selected channel on the entire screen of a display unit.

However, the user may not necessarily view a program on the same channel as a channel a program on which the user was viewing immediately before the user powered off the video display apparatus last time. In view of this, a method was proposed in which a channel to which a video display apparatus should be tuned is determined according to a time slot when the user activates the video display apparatus, that is, the video display apparatus is tuned to a channel a program on which the user views habitually in the time slot concerned. And a program on the selected channel is displayed on the entire screen of a display unit. An example of such method is disclosed in JP-A-2001-185992.

On the other hand, recent video display apparatus are connected to various networks such as the Internet and to various devices such as a video recorder through the network. Furthermore, it is expected that in the future other home electrical appliances such as a refrigerator and an air-conditioner will be connected to a video display apparatus through the network. It is therefore expected that the user will come to activate a video display apparatus for a variety of purposes such as downloading of a content such as a moving image or music over the Internet, viewing of a content stored in a video recorder, and operation of other home electrical appliance such as a refrigerator or an air-conditioner. However, conventionally, a TV program is displayed even when the user activates a video display apparatus for a purpose other than viewing of a TV program. Conventional video display apparatus are thus low in convenience.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 shows an example network system according to a embodiment.

FIG. 2 shows an example arrangement of operation buttons of a remote controller.

FIG. 3 shows an example screen that is displayed on a video display after activation of a video display apparatus according to the embodiment.

FIG. 4 shows an example detailed configuration of the video display apparatus according to the embodiment.

FIG. 5 is a functional block diagram showing functions of a control module of the video display apparatus according to the embodiment.

FIG. 6 is a flowchart of an operation of the video display apparatus 1 according to the embodiment.

### DETAILED DESCRIPTION OF THE EMBODIMENTS

An embodiment of the present invention will be hereinafter described in detail with reference to the drawings.

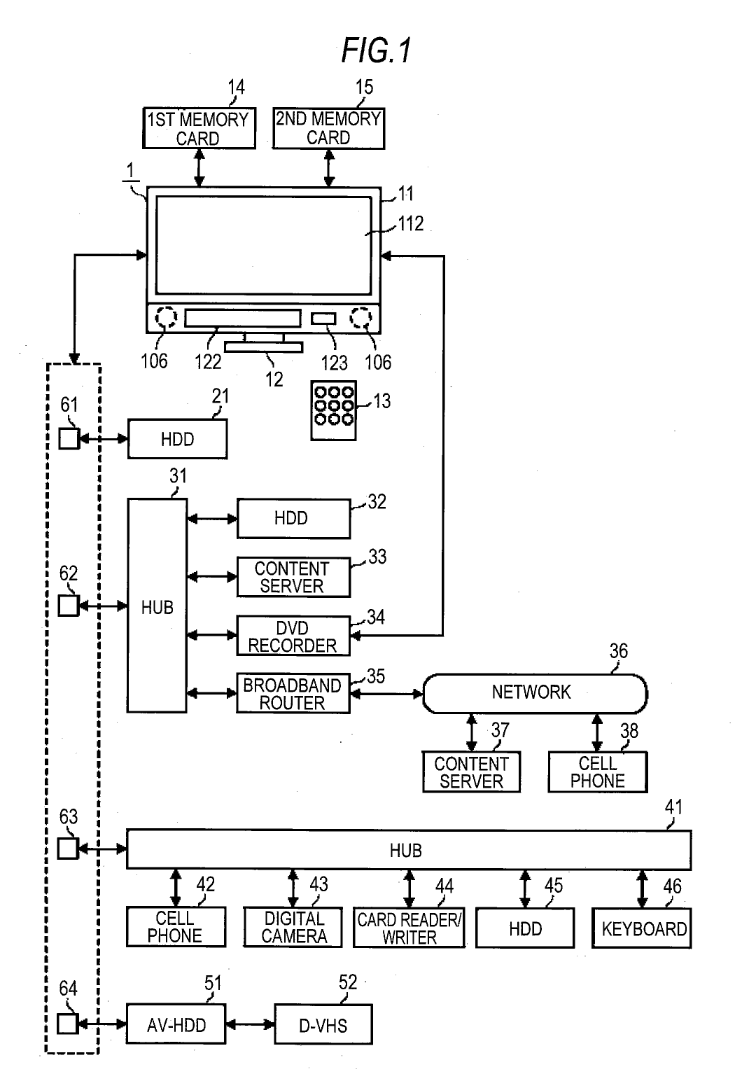

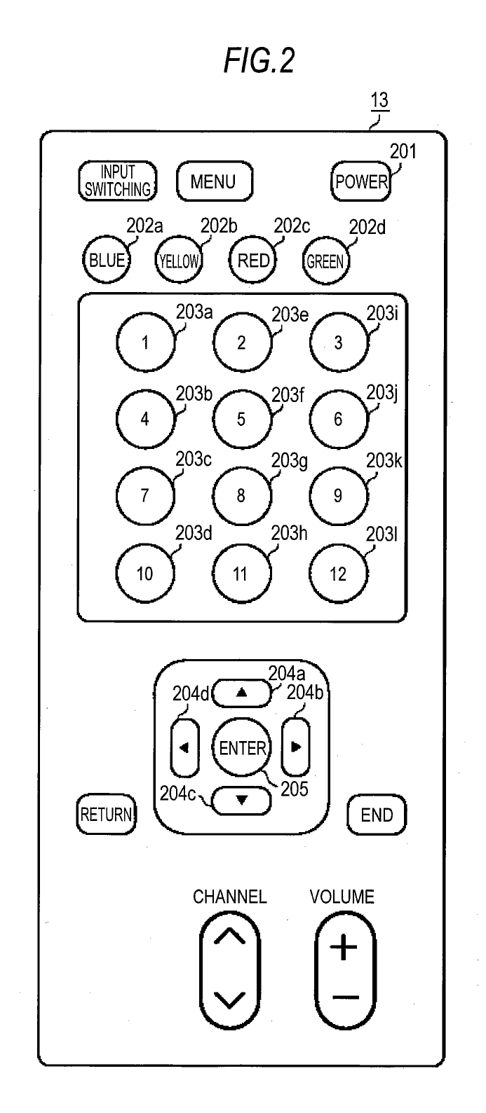

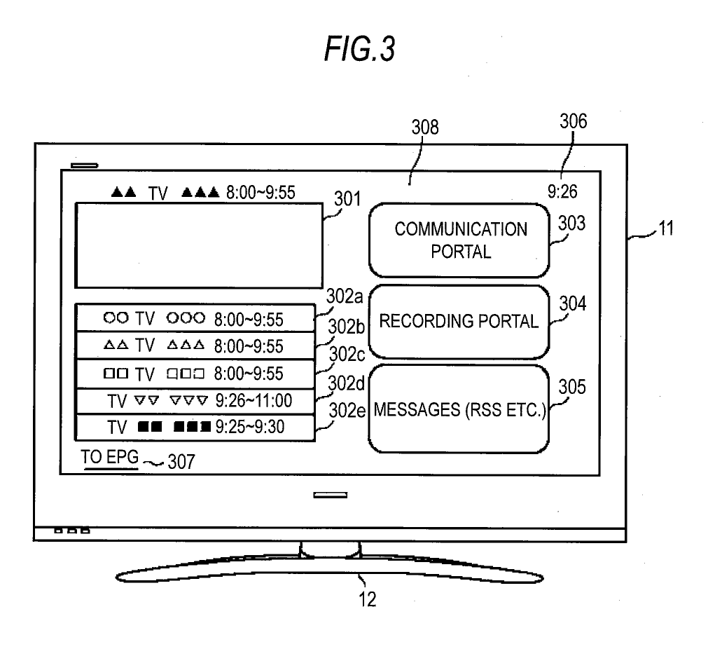

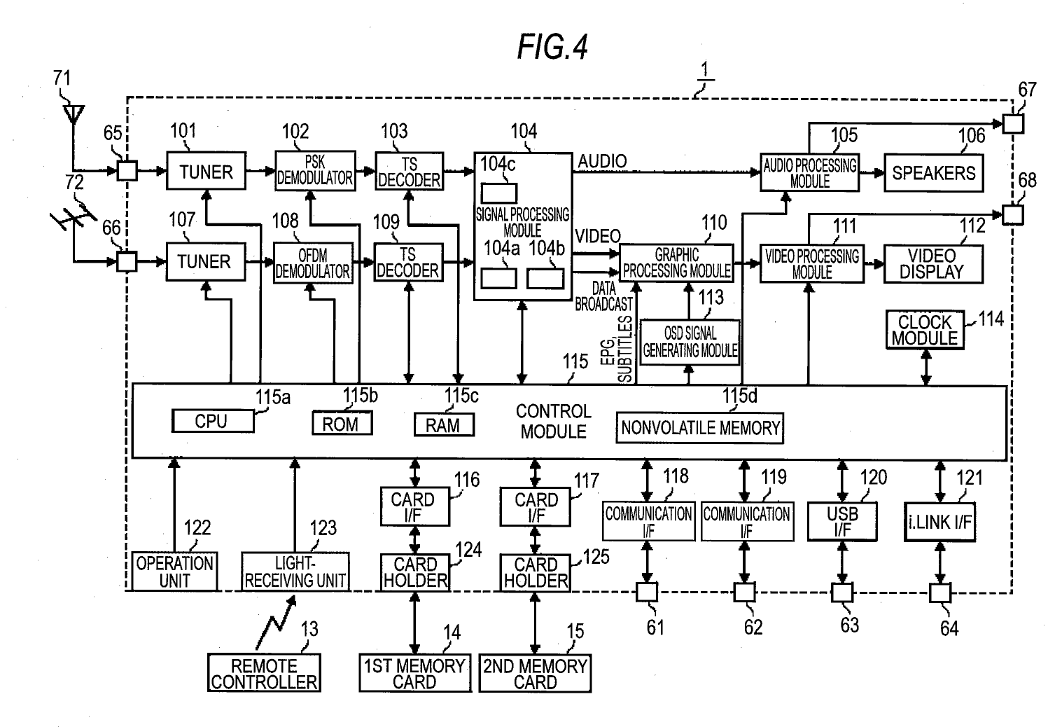

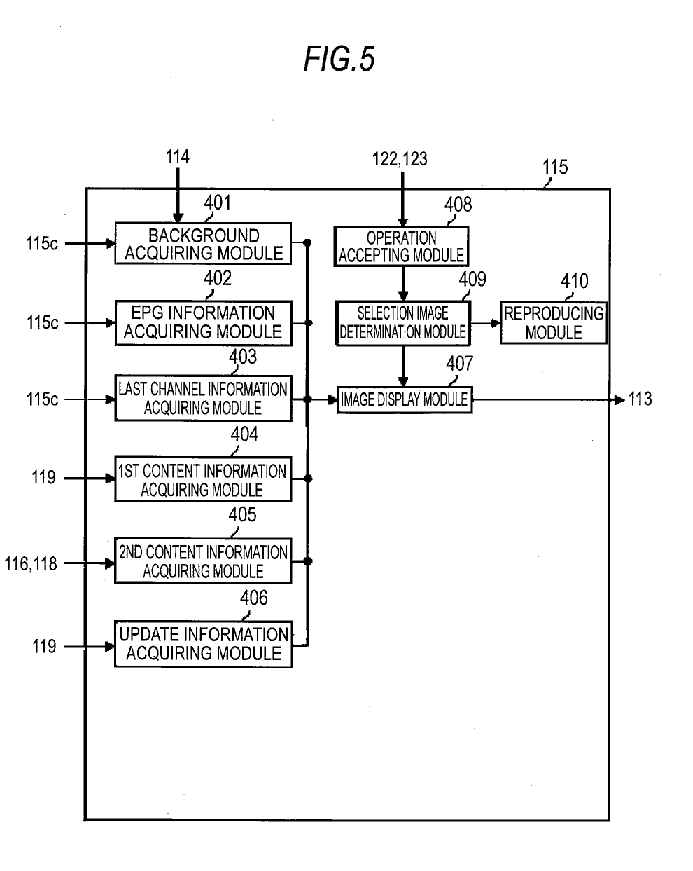

FIG. 1 shows a video display apparatus 1 according to an embodiment and an example network system which is configured so as to be centered by the video display apparatus 1. FIG. 2 shows an example arrangement of operation buttons of a remote controller 13. FIG. 3 shows an example screen that is displayed on a video display 112 after activation of the video display apparatus 1. FIG. 4 shows an example detailed configuration of the video display apparatus 1 according to the embodiment. FIG. 5 is a functional block diagram showing functions of a control module 115 of the video display apparatus 1 according to the embodiment.

The video display apparatus 1 according to the embodiment will be described below with reference to FIGS. 1-5. The embodiment assumes that the video display apparatus 1 is a digital TV broadcast receiver.

The video display apparatus 1 is equipped with a thin cabinet 11 and a support leg 12 for supporting the cabinet 11 so as to stand upright. The cabinet 111 is equipped with a flat video display 112 such as an SED (surface-conduction electron-emitter display) panel or a liquid crystal panel, speakers 106, a operation unit 122, and a light-receiving unit 123 for receiving operation information that is transmitted form the remote controller 13.

A memory card (hereinafter referred to as a first memory card) 14 such as an SD (secure digital) memory card, an MMC (multimedia card), a memory stick, or a USB (universal serial bus) memory is connected to the video display apparatus 1. The video display apparatus 1 stores contents such as TV programs and photographs and reproduces or displays a content(s) stored in the first memory card 14.

An IC (integrated circuit) card (hereinafter referred to as a second memory card) 15 which is stored with contract information etc. is also connected to the video display apparatus 1. The video display apparatus 1 writes and reads contract information etc. to and from the second memory card 15.

The video display apparatus 1 is equipped with a first LAN (local area network) terminal 61, a second LAN terminal 62, a USB terminal 63, and an i.LINK terminal 64. The first LAN terminal 61 is used as a port that is dedicated to a LAN-compatible HDD (hard disk drive). The first LAN terminal 61 is used for recording information in a LAN-compatible HDD 21 (NAS: network attached storage) connected to it and reproducing information recorded therein according to Ethernet (registered trademark).

Equipped with the first LAN terminal 61 which is a port dedicated to a LAN-compatible HDD, the video display apparatus 1 can record information of a Hi-Vision-quality program stably in the HDD 21 without being affected by other network environments, network use states, etc.

The second LAN terminal 62 is used as a general LAN-compatible port using Ethernet. The second LAN terminal 62 is connected to a LAN-compatible HDD 32, a content server 33, a DVD (digital versatile disc) recorder 34 incorporating an HDD, etc. via a hub 31. The second LAN terminal 62 is used for exchanging information with the above apparatus connected thereto.

The second LAN terminal 62 is also connected to a network 36 such as the Internet via a broadband router 35 which is connected to the hub 31. The second LAN terminal 62 is used for exchanging information with a content server 37, a cell phone 38, etc. over the network 36.

Digital information that is communicated via the second LAN terminal 62 is only control-related information. Therefore, the DVD recorder 34 has an analog transmission line which is dedicated to exchange of analog video and audio information with the video display apparatus 1.

The content server 33 operates as a content server in a home network. The content server 33 is configured as a UPnP (universal plug and play)-compatible apparatus having a service of providing URI (uniform resource identifier) information that is necessary for accessing a content.

The content server 37 has such a function as to operate as a content server. The content server 37 is configured as a UPnP-compatible apparatus having a service of providing URI information that is necessary for accessing a content.

The USB terminal 63 is used as a general USB-compatible port. For example, the USB terminal 63 is connected to USB devices such as a cell phone 42, a digital camera 43, a card reader/writer 44 for a memory card, an HDD 45, and a keyboard 46 via a hub 41. The video display apparatus 1 exchanges information with the above USB devices which are connected to the USB terminal 63.

For example, a serial connection of an AV-HDD 51 and a D (digital)-VHS (video home system) recorder 52 is connected to the i.LINK terminal 64. The video display apparatus 1 exchanges information with these apparatus which are connected to the i.LINK terminal 64.

FIG. 2 shows an example arrangement of operation buttons of the remote controller 13.

A power button 201, color buttons 202a-202d, tuning buttons 203a-203l, selection buttons 204a-204d, an enter button 205, etc. are arranged in the remote controller 13.

The power button 201 is a operation button for powering on and off the video display apparatus 1. The color buttons 202a-202d are operation buttons for adjusting the hue of an image displayed on the video display 112.

The tuning buttons 203a-203l are operation buttons for switching the channel of a program to be displayed on the video display 112. For example, if the tuning button 203a is manipulated, the video display apparatus 1 is tuned to channel 1 and a program on the selected channel 1 is displayed on the video display 112.

The selection buttons 204a-204d are operation buttons for moving a cursor that is displayed on the video display 112. An item or a set value that is displayed on the video display 112 can be selected or changed by manipulating the selection buttons 204a-204d. The enter button 205 is a operation button for deciding on an item selected by the selection buttons 204a-204d. The user can also perform manipulations corresponding to the above using the operation unit 122 of the video display apparatus 1.

FIG. 3 shows an example screen (hereinafter referred to as an initial screen) that is displayed on the video display 112 after activation of the video display apparatus 1. A last channel display area 301, a program information display area 302, a communication portal display area 303, a recording portal display area 304, a message display area 305, a present time 306, a link button 307 to an electronic program guide (hereinafter abbreviated as EPG), etc. are displayed on the video display 112 so as to be superimposed on a background 308.

The last channel display area 301, the program information display area 302, the communication portal display area 303, the recording portal display area 304, and the message display area 305 are displayed on the video display 112 simultaneously after activation of the video display apparatus 1. The term “simultaneously” as used herein means that the user visually feels that they are displayed simultaneously, and they need not be displayed with exact simultaneity.

FIG. 3 shows an initial screen which is displayed when the video display apparatus 1 is powered on at 9:26. In the following description, the last channel display area 301, the program information display area 302, the communication portal display area 303, the recording portal display area 304, and the message display area 305 are referred to as display areas 301, 302, 303, 304, and 305, respectively.

A current program on a channel (hereinafter referred to as a last channel) a program on which the user was viewing when the video display apparatus 1 was powered off last time is displayed in the display area 301. A program name, a broadcasting station name, and a broadcast period of the program being displayed in the display area 301 are displayed at a top position of the display area 301. If the user operates the enter button 205 of the remote controller 13 in a state that the display area 301 is selected, the video display apparatus 1 is tuned to the last channel. A program on the last channel is displayed on the entire screen of the video display 112.

Alternatively, programs corresponding to pieces of program information displayed in display areas 302a-302e may be displayed in the display area 301 so as to be switched at constant time intervals (zapping display). If the video display apparatus 1 is not manipulated for a given time after the user powered on it, the video display apparatus 1 is tuned to the last channel and video on the last channel is displayed on the entire screen of the video display 112.

The display area 302 consists of the plural display areas 302a-302e. Pieces of information relating to programs being broadcast currently are displayed in the respective display areas 302a-302e. Each piece of program information displayed is a TV station name, a program name, a broadcast period, etc. The pieces of program information displayed in the respective display areas 302a-302e are based on an EPG that is stored in the video display apparatus 1.

First, the user selects one of the pieces of program information displayed in the display areas 302a-302e by manipulating the selection buttons 204a-204d. The selected display area is emphasized in such a manner that the color or font of the characters of the program information is changed.

Then, if the user operates the enter button 205 in a state that one of the pieces of program information is selected, the video display apparatus 1 is tuned to the channel corresponding to the selected program information. A program on that channel is displayed on the entire screen of the video display 112.

More detailed information of the selected program information (e.g., persons who appear in the program) may be displayed immediately after or a given time after the selection of one of the display areas 302a-302e.

Alternatively, part of the tuning buttons 203a-203l of the remote controller 13 may be correlated with the display areas 302a-302e so that when the user operates one of the part of the tuning buttons 203a-203l of the remote controller 13 the corresponding one of the display areas 302a-302e is selected.

Information of a site of a portal service which delivers information contents and moving image contents to digital TV receivers is displayed in the display area 303. For example, information of latest contents such as content titles and delivery start dates/times are displayed in the display area 303. If the user operates the enter button 205 in a state that the display area 303 is selected, a screen of the portal site is displayed on the entire screen of the video display 112. Information of contents that meet the tastes of the user may be displayed in the display area 303.

Information of a content that was recorded last time among the contents recorded in the HDD 21 and the DVD recorder 34 is displayed in the display area 304. If the user operates the enter button 205 in a state that the display area 304 is selected, the last-recorded content of the HDD 21 or the DVD recorder 34 is reproduced.

Information of a content recorded in the HDD 21 or the DVD recorder 34 may be displayed in the display area 304 according to the tastes of the user. Rather than information of a single content, information of plural contents may be displayed.

A summarized version of update information (hereinafter referred to as RSS (RDF site summary) information) delivered from each of various websites of news, blogs, etc. that are registered as favorites by the user is displayed in the display area 305. If the user operates the enter button 205 in a state that the display area 305 is selected, a screen of a website that delivered RSS information is displayed on the entire screen of the video display 112.

The blue, yellow, and red color buttons 202a-202c may be correlated with the respective display areas 303-305 so that when the user operates one of the color buttons 202a-202c the cursor is moved to the corresponding display area.

The EPG link button 307 serves for a jump to an EPG. If the user operates the enter button 205 after selecting the EPG link button 307 by manipulating the selection buttons 204a-204d of the remote controller 13, detailed program information of one week or one day is displayed on the entire screen of the video display 112.

As for the background 308, one of different background images is displayed depending on a time slot, a date, a season, or the like when the video display apparatus 1 is activated. For example, a night view is displayed as the background 308 if the video display apparatus 1 is activated at night.

To allow the user to recognize which of the display areas 301-305 is selected, the size or the like of a selected display area is varied dynamically. For example, if the display area 303 is selected, its size is varied.

If information to be displayed in one the display areas 303-305 cannot be acquired because a corresponding apparatus is not connected to the video display apparatus 1, that display area is not displayed on the video display 112.

Pieces of information that are displayed in the display areas 301 and 302 constitute first information, and pieces of information that are displayed in the display areas 303 and 305 constitute second information.

FIG. 4 shows an example detailed configuration of the video display apparatus 1.

An input terminal 65 serves to supply a satellite digital broadcast tuner 101 with a satellite digital TV broadcast signal (hereinafter referred to as a first broadcast signal) received by an antenna 71 for BS/CS digital broadcast reception.

The tuner 101 tunes in to a first broadcast signal on a desired channel supplied from the antenna 71 according to a control signal that is supplied from the control module 115. The tuner 101 outputs the thus-selected first broadcast signal to a PSK (phase shift keying) demodulator 102.

The PSK demodulator 102 demodulates the first broadcast signal (selected by the tuner 101) according to a control signal from the control module 115. The PSK demodulator 102 acquires a transport stream (hereinafter abbreviated as TS) including a desired program from the demodulated first broadcast signal and outputs it to a TS decoder 103.

The TS decoder 103 decodes the TS-multiplexed signal according to a control signal from the control module 115. The TS decoder 103 depacketizes a digital video signal and audio signal of the desired program, and outputs the resulting PESs (packetized elementary streams) to an STD buffer 104a of a signal processing module 104.

Furthermore, the TS decoder 103 outputs module information that is transmitted by the digital broadcast to a module processing module 104b of the signal processing module 104.

An input terminal 66 serves to supply a ground-wave digital broadcast tuner 107 with a ground-wave digital TV broadcast signal (hereinafter referred to as a second broadcast signal) received by an antenna 72 for ground-wave broadcast reception.

The tuner 107 tunes in to a second broadcast signal on a desired channel supplied from the antenna 72 according to a control signal that is supplied from the control module 115. The tuner 107 outputs the thus-selected second broadcast signal to an OFDM (orthogonal frequency division multiplexing) demodulator 108.

The OFDM demodulator 108 demodulates the second broadcast signal (selected by the tuner 107) according to a control signal from the control module 115. The OFDM demodulator 108 acquires a transport stream including a desired program from the demodulated second broadcast signal and outputs it to a TS decoder 109.

The TS decoder 109 decodes the TS-multiplexed signal according to a control signal from the control module 115. The TS decoder 109 depacketizes a digital video signal and audio signal of the desired program, and outputs the resulting PESs to the STD buffer 104a of the signal processing module 104.

Furthermore, the TS decoder 109 outputs module information that is transmitted by the digital broadcast to the module processing module 104b of the signal processing module 104.

During TV viewing, the signal processing module 104 performs given digital signal processing selectively on the digital video signal and audio signal supplied from the TS decoder 103 or those supplied from the TS decoder 109. The signal processing module 104 outputs the resulting signals to a graphic processing module 110 and an audio processing module 105, respectively.

During content reproduction, the signal processing module 104 selects content reproduction signals that are supplied form the control module 115 and performs given digital signal processing on them. The signal processing module 104 outputs the resulting signals to the graphic processing module 110 and the audio processing module 105, respectively.

The module processing module 104b of the signal processing module 104 acquires various data for acquisition of a program, electronic program guide (EPG) information, program attribute information (a program genre etc.), subtitle information (service information (SI or PSI)), etc. from the module information supplied from each of the TS decoders 103 and 109, and outputs them to the control module 115.

The control module 115 performs video generation processing for displaying an EPG and subtitles on the basis of the information supplied from the signal processing module 104, and outputs generated video information to the graphic processing module 110. The EPG information supplied from the signal processing module 104 is stored in a nonvolatile memory 115d.

The graphic processing module 110 has a function of combining the digital video signal that is supplied from an AV decoder 104c of the signal processing module 104, an OSD (on-screen display) signal that is generated by an OSD signal generating module 113, video data of a data broadcast, the EPG and the subtitle signal that are generated by the control module 115, and outputting the resulting signal to a video processing module 111.

When subtitles of a subtitled broadcast are to be displayed, the graphic processing module 110 performs processing of superimposing subtitle information (supplied from the control module 115) on the video signal.

The digital video signal that is output from the graphic processing module 110 is supplied to the video processing module 111. The video processing module 111 converts the received digital video signal into an analog video signal having such a format as to be able to be displayed on the video display 112. The video processing module 111 outputs the resulting analog video signal to the video display 112. Furthermore, the video processing module 111 outputs the analog video signal to the outside via an output terminal 68.

An audio processing module 105 converts the received digital audio signal into an analog audio signal having such a format as to be able to be reproduced by the speakers 106. The audio processing module 105 outputs the resulting analog audio signal to the speakers 106. Furthermore, the audio processing module 105 outputs the analog audio signal to the outside via an output terminal 67. A clock module 114 counts a current time.

The control module supervises all operations including the receiving operation of the video display apparatus 1. The control module 115 is equipped with a CPU (central processing unit) 115a, a ROM (read-only memory) 115b which is stored with control programs to be run by the CPU 115a, a RAM (random access memory) 115c which provides a work area for the CPU 115a, the nonvolatile memory 115d which is stored with various pieces of setting information, control information, and other information, and other devices.

The control module 115 receives operation information from the operation unit 122. The control module 115 also receives, via the light-receiving unit 123, operation information that is transmitted from the remote controller 13. The control module 115 controls the individual modules of the video display apparatus 1 according to the received operation information.

The control module 115 is connected to a card holder 124 via a card interface (I/F) 116. The first memory card 14 is inserted in the card holder 124. The control module 115 exchanges information with the first memory card 14 inserted in the card holder 124 via the card I/F 116.

The control module 115 is connected to a card holder 125 via a card interface (I/F) 117. The second memory card 15 is inserted in the card holder 125. The control module 115 exchanges information with the second memory card 15 inserted in the card holder 125 via the card I/F 117.

The control module 115 is connected to the first LAN terminal 61 via a communication I/F 118. The control module 115 exchanges, via the communication I/F 118, information with the HDD 21 which is connected to the first LAN terminal 61. In doing so, the control module 115, which has a DHCP (dynamic host configuration protocol) server function, controls the HDD 21 by assigning an IP (Internet protocol) address to it.

The control module 115 is connected to the second LAN terminal 62 via a communication I/F 119. The control module 115 exchanges, via the communication I/F 119, information with the individual apparatus connected to the second LAN terminal 62.

The control module 115 is connected to the USB terminal 63 via a USB I/F 120. The control module 115 exchanges, via the USB I/F 120, information with the individual devices connected to the USB terminal 63.

The control module 115 is connected to the i.LINK terminal 64 via an i.LINK I/F 121. The control module 115 exchanges, via the i.LINK I/F 121, information with the individual apparatus connected to the i.LINK terminal 121.

The nonvolatile memory 115c is stored with EPG information that is supplied from the signal processing module 104. The nonvolatile memory 115c is also stored with information of a last channel a program on which was viewed last time. This last channel information is updated every time the user powers off the video display apparatus 1. The nonvolatile memory 115c is also stored with plural background images to be displayed on the video display 112 as the background 308 in such a manner that they are correlated with respective seasons, dates, or time slots.

Furthermore, the nonvolatile memory 115c is stored with URLs (uniform resource locators) that are registered by the user as favorites. The nonvolatile memory 115c is also stored with designations of apparatus etc. from which information to be displayed in the display areas 301-305 (described above with reference to FIG. 3) should be acquired, respectively. Alternatively, pieces of background image information may be stored in a memory (hereinafter referred to as an external memory) that is located outside the control module 115, for example, the first memory card 14 or the HDD 21.

The nonvolatile memory 115c or the external memory constitutes first and second storage modules.

FIG. 5 is a functional block diagram showing functions of the control module 115 of the video display apparatus 1 according to the embodiment. FIG. 5 shows only major functions of the video display apparatus 1 according to the embodiment. The functions shown in FIG. 5 are realized by the CPU 115a's running control programs stored in the ROM 115b.

A background acquiring module 401 acquires a current time from the clock 114 every given time, and acquires the background image corresponding to the current time (acquired from the clock 14) from the nonvolatile memory 115c or the external memory.

An EPG information acquiring module 402, a last channel information acquiring module 403, a first content information acquiring module 404, and a second content information acquiring module 405 acquire pieces of information to be displayed in the display areas 301-305 on the basis of the designations of apparatus etc. from which to acquire information that are stored in the nonvolatile memory 115c.

The EPG information acquiring module 402 acquires EPG information to be displayed in the display area 302 from the nonvolatile memory 115c or the external memory. The last channel information acquiring module 403 acquires last channel information to be displayed in the display area 301 from the nonvolatile memory 115c or the external memory.

The first content information acquiring module 404 acquires content information to be displayed in the display area 303 via the communication I/F 119. The second content information acquiring module 405 acquires content information to be displayed in the display area 304 via the card I/F 116 or the communication I/F 118. An update information acquiring module 406 acquires, via the communication I/F 119, information to be displayed in the display area 305, that is, update information that is delivered from the websites that are registered by the user as favorites.

If a operation accepting module 408 accepts a power-on operation, an image display module 407 generates an image signal in which signals for the display areas 301-305, the present time 306, and the EPG link button 307 (described above with reference to FIG. 3) are superimposed on a signal of a background image acquired by the background acquiring module 401. Furthermore, the image display module 407 emphasizes a display area that has been selected by the user.

The image signal generated by the image display module 407 is converted by the OSD signal generating module 113 into an OSD signal, which is converted by the video processing module 111 into an analog video signal, which is input to the video display 112. As a result, a screen as shown in FIG. 3 is displayed on the video display 112.

The operation accepting module 408 accepts the user's operation, made through the operation unit 122 or received by the light-receiving unit 123, of selecting or deciding on one of the display areas 301-305. A selection image determination module 409 determines which of the display areas 301-305 being displayed on the video display 112 is selected.

If a given time has elapsed or the operation accepting module 408 accepts an enter operation in a state that the display area 301 is selected, the selection image determination module 409 instructs the tuner 101 or 107 to tune in to the last channel. The tuner 101 or 107 tunes in to the last channel. As a result, a program on the channel selected by the tuner 101 or 107 is displayed on the video display 112.

If a given time has elapsed or the operation accepting module 408 accepts an enter operation in a state that one of the display areas 302a-302e is selected, the selection image determination module 409 instructs the tuner 101 or 107 to tune in to the channel corresponding to the selected display area. The tuner 101 or 107 tunes in to the channel corresponding to the selected display area. As a result, a program on the channel selected by the tuner 101 or 107 is displayed on the video display 112.

If a given time has elapsed or the operation accepting module 408 accepts an enter operation in a state that the display area 303 is selected, the selection image determination module 409 instructs the image display module 407 to display a screen of the portal service site. According to the instruction from the selection image determination module 409, the image display module 407 displays the screen of the portal service site on the entire screen of the video display 112.

If a given time has elapsed or the operation accepting module 408 accepts an enter operation in a state that the display area 304 is selected, the selection image determination module 409 instructs a reproducing module 410 to reproduce a content corresponding to content information that is displayed in the display area 304. The reproducing module 410 reproduces the content according to the instruction from the selection image determination module 409.

If a given time has elapsed or the operation accepting module 408 accepts an enter operation in a state that the display area 305 is selected, the selection image determination module 409 instructs the image display module 407 to display a screen of a website that delivered RSS information being displayed in the display area 305. According to the instruction from the selection image determination module 409, the image display module 407 displays the screen of the website that delivered the RSS information on the entire screen of the video display 112.

The image display module 407 serves as a display module. The EPG information acquiring module 402, the last channel information acquiring module 403, the first content information acquiring module 404, and the second content information acquiring module 405 serves as an information acquiring module.

Next, a description will be made of an operation of the video display apparatus 1 according to the embodiment.

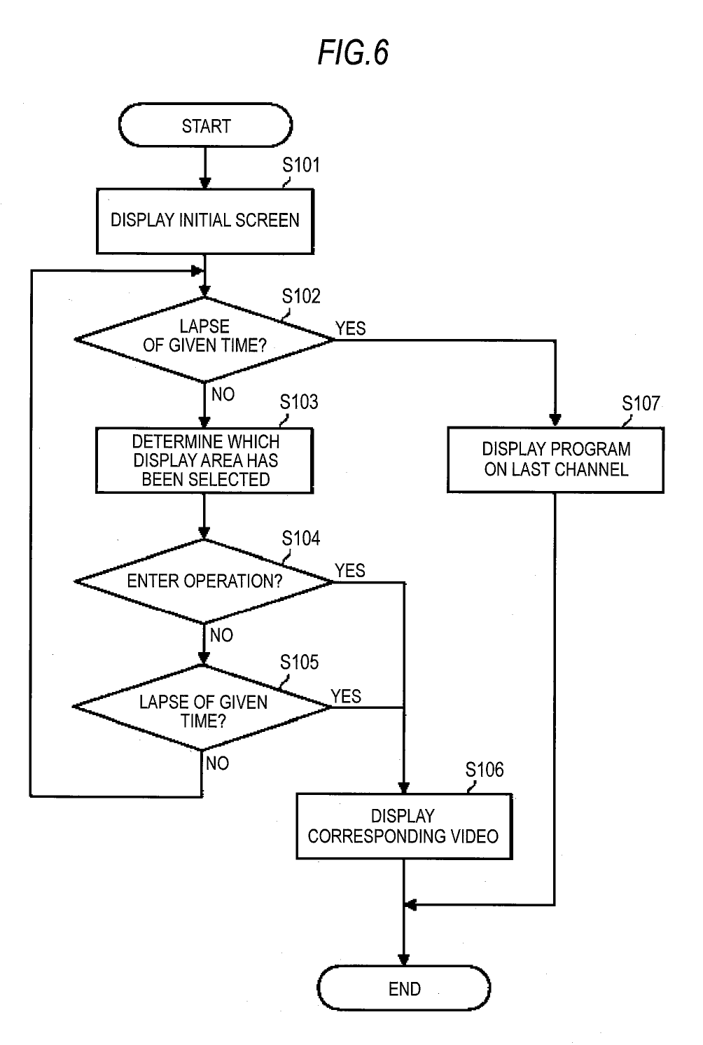

FIG. 6 is a flowchart of an example operation of the video display apparatus 1 according to the embodiment.

If the operation accepting module 408 accepts a power-on operation, at step S101 the image display module 407 generates an image signal in which signals for the display areas 301-305, the present time 306, and the EPG link button 307 are superimposed on a signal of a background image and displays an initial screen as shown in FIG. 3 on the video display 112.

At step S102, the selection image determination module 409 determines whether a given time has elapsed from a time of reception of the power-on operation. If the given time has elapsed (S102: yes), at step S107 the selection image determination module 409 gives the tuner 101 or 107 an instruction to tune in to the last channel and displays a program on the last channel on the video display 112.

If the given time has not elapsed yet (S102: no), at step S103 the selection image determination module 409 determines which of the display areas 301-305 is selected. The image display module 407 emphasizes the selected display area. At step S104, the selection image determination module 409 determines whether the operation accepting module 408 has accepted an enter operation in a state that one of the display areas 301-305 is selected.

If the operation accepting module 408 has not accepted an enter operation (S104: no), the selection image determination module 409 determines at step S105 whether a given time has elapsed in a state that one display area is selected. If the given time has not elapsed yet (S105: no), the process returns to step S102.

If the operation accepting module 408 has accepted an enter operation (S104: yes) or the given time has elapsed (S105: yes), at step S106 video corresponding to the selected display area is displayed on the video display 112.

More specifically, if the display area 301 is selected, a program on the last channel is displayed. If the display area 302 is selected, a program on the channel corresponding to selected program information is displayed. If the display area 303 is selected, a screen of the portal service site is displayed. If the display area 304 is selected, a content recorded in the HDD 21 or the DVD recorder 34 is reproduced. If the display area 305 is selected, a screen of a website that delivered RSS information is displayed.

As described above, after its activation, the video display apparatus 1 according to the embodiment displays the display areas 301-305 shown in FIG. 3 on the video display 112. If the user selects one of the display areas 301-305, a corresponding screen is displayed on the entire screen of the video display 112. As such, the video display apparatus 1 can accommodate a variety of purposes of the user such as downloading of a content (e.g., a moving image or music) over the Internet and viewing of a content stored in a video recorder. The video display apparatus 1 is thus high in ease of use (convenience).

Part of the tuning buttons 203a-203l of the remote controller 13 may be correlated with the respective display areas 302a-302e. In this case, if the user operates one of the part of the tuning buttons 203a-203l, the corresponding one of the display areas 302a-302e is selected. The blue, yellow, and red color buttons 202a-202c of the remote controller 13 may be correlated with the respective display areas 303-305. In this case, if the user operates one of the color buttons 202a-202c, the cursor is moved to the corresponding display area. These measures also enhance the ease of operation.

One of different backgrounds is displayed depending on a season, a date, or a time slot when the video display apparatus 1 is activated. This allows the user to feel a season or recognize a time slot, which in turn allows the user to select a content or a program to view according to a current season, date, or time slot.

It is possible to connect another home electrical appliance such as a refrigerator or an air-conditioner to the video display apparatus 1 via a network and to display information of the connected home electrical appliance in the initial screen of the video display apparatus 1. A temperature, electric energy used, or the like may be displayed as the information of the home electrical appliance. Furthermore, the video display apparatus 1 may be configured so as to be able to manipulate the connected home electrical appliance.

Although the embodiment according to the present invention has been described above, the present invention is not limited to the above-mentioned embodiment but can be variously modified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A video display apparatus comprising:
a tuner configured to receive a digital broadcast signal;
an accepting module configured to accept a power-on command; and
a display module configured to simultaneously display first information that is included in the digital broadcast signal and second information that is not included in the digital broadcast signal when the accepting module accepts the power-on command.

2. The apparatus of claim 1, wherein the first information is program information.

3. The apparatus of claim 1, wherein the second information is information that is stored in an external apparatus that is connected to the video display apparatus.

4. The apparatus of claim 1, wherein the accepting module is configured to accept a selection command for selecting one of the first information and the second information, and
wherein the display module is configured to display the selected one of the first information and the second information to be emphasized.

5. The apparatus of claim 4, wherein the display module is configured to display a program on the same channel as a channel to which the tuner was tuned when the apparatus was powered off last time when the accepting module fails to receive the selection command within a given time period.

6. The apparatus of claim 1, wherein, when a given time period has elapsed in a state where one of the first information and the second information is being selected, the display module displays detailed information of the selected one of the first information and the second information.

7. The apparatus of claim 1 further comprising:
a clock module configured to count current date and time;
a storage module configured to store a plurality of background images corresponding to respective time periods of the date and time; and
a background acquiring module configured to acquire from the storage module one of the background images corresponding to a current time period when the accepting module accepts the power-on command,
wherein the display module is configured to display the first information and the second information in a manner being superimposed on the acquired one of the background images.

8. A method for displaying video comprising:
accepting a power-on command; and
simultaneously displaying first information that is included in a digital broadcast signal and second information that is not included in the digital broadcast signal when the power-on command is accepted.
